(19) United States
(12) Patent Application Publication
(10) Pub. No.: US 2024/0403910 A1
(43) Pub. Date: Dec. 5, 2024

(54) ADVERTISING EXPRESSION ASSESSMENT DEVICE, AND STORAGE MEDIUM

(71) Applicant: ART WORKS Consulting Co.,Ltd., Tokyo (JP)

(72) Inventor: Satoshi TAKAHASHI, Tokyo (JP)

(73) Assignee: ART WORKS Consulting Co.,Ltd., Tokyo (JP)

(21) Appl. No.: 18/575,815

(22) PCT Filed: Aug. 16, 2022
(86) PCT No.: PCT/JP2022/030996

§ 371 Date: Aug. 13, 2024

(51) Int. Cl. G06Q 30/0242; G06Q 30/0241

(52) U.S. Cl. CPC G06Q 30/0244; G06Q 30/0277

(57) ABSTRACT

The advertising expression assessment device of this invention is equipped with a storage unit that stores assessment data for determining the usage acceptability of an advertising expression in multiple countries based on advertising review guidelines, an acquisition unit that obtains the advertising expression, a translation unit that obtains language expressions translated into the language of each of said countries for the obtained advertising expression, an expression assessment unit that determines the usage acceptability to ascertain whether an advertising expression is acceptable for use in each of said countries based on the assessment data, and an output unit that outputs display data listing the language expressions for each of said countries and their respective usage acceptability.

### TECHNICAL FIELD

The present invention relates to an assessment device for advertising expression which determines the usage acceptability of an advertising expression.

### BACKGROUND ART

As a device for assessing advertising expressions, an example is a display information assessment device as described in Patent Document 1. This device features a database of messages prohibited under laws and regulations such as the Pharmaceutical and Medical Device Act and the Act against Unjustifiable Premiums and Misleading Representation. It searches the database for entered advertising messages to determine their permissibility for use.

(Patent reference literature 1) Japanese Patent Application No. 2019-079275

### SUMMARY OF THE INVENTION

### Problems to be Solved by the Invention

However, laws and regulations concerning advertising expressions that are not permitted for use vary by country. Therefore, an expression prohibited in one country may be allowed in another. Conversely, expressions that are naturally deemed acceptable in one's own country might be prohibited in others. For example, the term “baby bottle” is routinely used in Japan but is not acceptable in advertising in Brazil and India due to associations with infant obesity. Additionally, each advertising medium, such as Google (registered trademark) AD and TikTok (registered trademark) AD, has distinct advertising review guidelines. Advertisements are reviewed in each country based on these guidelines. As a result, an expression that passes review in one country may fail in another.

In this regard, it is conceivable that a database of laws, regulations, and guidelines could be created to meet global specifications, and advertising expressions of each country could be assessed for their applicability by comparing them with the laws, regulations, and guidelines of other countries. However, it is a time-consuming effort to translate and assess each country's advertising expression separately. For example, when running web and video advertisements targeting different countries, it is necessary to go through advertising reviews in various countries. In these cases, it is not easy to determine for each advertising expression whether it is acceptable (OK) or not (Not OK) in each country.

In view of such circumstances, the present invention aims to provide an advertising expression assessment device that can determine at a glance the usage acceptability of each advertising expression in different countries by displaying a list of the usage acceptability of advertising expressions for each country.

### Solution to Problem

To address the above-mentioned challenges, the advertising expression assessment device of this invention includes: a storage unit that stores assessment data for determining the usage acceptability of an advertising expression in multiple countries based on advertising review guidelines, an acquisition unit that obtains the advertising expression, a translation unit that obtains language expressions translated into the language of each of said countries for the obtained advertising expression, an expression assessment unit that determines the usage acceptability to ascertain whether an advertising expression is acceptable for use in each of said countries based on the assessment data, and an output unit that outputs display data listing the language expressions for each of said countries and their respective usage acceptability According to this device, for each acquired advertising expression, a list displaying the language expression and the usage acceptability for each country is shown. Therefore, it is possible to immediately discern whether the advertising expression is acceptable or not in each country. Thus, it becomes clear whether the advertising expression meets the advertising review standards of each country, allowing for an instant understanding of which countries' advertising reviews the expression can pass.

In the preferred embodiment of the present invention, the assessment data includes the country-specific language expressions and the country-specific usage acceptability for advertising expressions that are not acceptable in at least one country for each of the multiple review guidelines. By assessing the advertising expression using the assessment data in this embodiment, it is possible to determine for each review guideline whether the advertising expression meets the advertising review standards of each country. The assessment data includes country-specific language expressions and the country-specific usage acceptability for advertising expressions that are not acceptable in at least one country under each of the multiple review guidelines. Therefore, when planning to advertise in multiple countries in accordance with the review guidelines, it is easy to confirm for each country whether the advertising expression will pass the advertising review.

In the preferred embodiment of the present invention, the advertising expressions are included in web advertisements. The acquisition unit obtains the advertising expression based on the URL of the web advertisement, and the display data includes data that displays at least the number of the advertising expressions not acceptable for use in each country. According to this embodiment, since the advertising expressions are obtained based on the URL of the web advertisement, the advertising expressions included in the web advertisement can be determined at once. This significantly saves time and effort in determining the advertising expressions. Furthermore, the system includes display data that shows the number of advertising expressions not acceptable for use in each country, making it easy to ascertain how many additional advertising expressions need modification to pass the advertising review in each country.

In the preferred embodiment of the present invention, the display data includes the display of the web advertisement with a highlight on an advertising expression that has been determined to be not acceptable in at least one of the countries, and when the cursor is placed over the advertising expression with highlighted, a pop-up display appears, showing at least the countries where the use of the advertising expression is not acceptable. According to this embodiment, the advertising expressions on the web advertisements that are not acceptable for use by which countries can be seen at a glance.

In the preferred embodiment of the present invention, the web advertisement is a video, and the acquisition unit obtains the advertising expressions from speech-to-text converted data from the video based on the URL of the web advertisement. According to this embodiment, even if the web advertisement is a video, the advertising expressions are obtained from the speech-to-text converted data of the video, allowing them to be assessed in the same manner as when the web advertisement is not a video. This enables the display of the usage acceptability list of advertising expressions for each country at a glance. Therefore, it is easy to discern at a glance in which countries the advertising expressions are acceptable or not. Moreover, since the advertising expressions included in the web advertising video can be determined at once, the time and effort required for assessing these expressions can be significantly reduced.

In the preferred embodiment of the present invention, the display data includes a display of a world map, markers showing the location on the world map of the countries where at least the advertising expression is not acceptable, and a popup display associated with said markers, showing the countries where at least the advertising expression is not acceptable. According to this embodiment, it is possible to understand in which countries the advertising expression is not acceptable for use, based on its location on the world map. Particularly, even when the advertising expression is not acceptable in multiple countries, it is easy to discern at a glance the countries and regions where it is not acceptable. Additionally, the display data includes a pop-up display associated with markers on the world map, showing at least the countries where the advertising expression is not acceptable, thereby enabling the identification of these countries at a glance on the world map.

In the preferred embodiment of the present invention, the display data includes data that displays the reasons why the advertising expression is not acceptable in that country. According to this embodiment, it becomes easier to modify the advertising expression as it is possible to understand the reasons why the advertising expression is not acceptable in that country.

In the preferred embodiment of the present invention, a tangible non-transitory computer-readable storage medium that stores a program for a computer to execute an advertisement assessment process for assessing advertising expressions for each of multiple countries based on advertising review guidelines. The advertisement assessment process comprising the steps of: acquiring an advertising expression; obtaining language expressions translated into the language of each of said countries for the obtained advertising expression; determining a usage acceptability to ascertain whether the advertising expression is acceptable for use in each of said countries based on the advertising review guidelines; and outputting display data listing the language expressions for each of said countries and their respective usage acceptability. Advertisement assessment processing can be executed by reading and executing the program stored in the storage medium of present embodiment with a computer, and the computer can function as an advertising expression assessment device.

To solve the above challenge, a computer readable program on a tangible non-transitory computer-readable storage medium for controlling a computer to execute an advertisement assessment process for assessing advertising expressions for each of multiple countries based on advertising review guidelines. The advertisement assessment process including the steps of: acquiring an advertising expression; obtaining language expressions translated into the language of each of said countries for the obtained advertising expression; determining a usage acceptability to ascertain whether the advertising expression is acceptable for use in each of said countries based on the advertising review guidelines; and outputting display data listing the language expressions for each of said countries and their respective usage acceptability. By executing the program of this embodiment, the advertisement assessment processing can be executed, and the computer can function as an advertising expression assessment device.

### Effect of the Invention

According to the present invention, by displaying a list showing the usage acceptability of advertising expressions for each country, it becomes possible to quickly discern at a glance whether an advertising expression is acceptable or not in each country.

### BRIEF DESCRIPTION OF THE DRAWINGS

FIG. 1 is a diagram illustrating a configuration example of an advertising expression assessment system for the first embodiment of the invention;

FIG. 2 is a block diagram showing a configuration example of the advertising expression assessment device and terminal device;

FIG. 3 is a diagram illustrating a specific example of the country-specific advertisement assessment database (DB);

FIG. 4 showing a specific example of the description database (DB);

FIG. 5 showing a specific example of the alternative expression database (DB);

FIG. 6 is a diagram showing a specific example of the assessment result database (DB);

FIG. 7 illustrates a specific example of the word input screen for the first embodiment;

FIG. 8 illustrates a specific example of the advertising expression assessment result screen for the first embodiment;

FIG. 9 is a flowchart showing a specific example of the advertisement assessment processing for the first embodiment;

FIG. 10 is a flowchart showing a specific example of the advertising expression assessment processing in FIG. 9;

FIG. 11 is a block diagram showing a configuration example of the advertising expression assessment device and terminal device for the second embodiment;

FIG. 12 illustrates a specific example of the web Ad Site URL input screen for the second embodiment;

FIG. 13 illustrates a specific example of the advertising expression assessment result screen for the second embodiment;

FIG. 14 illustrates a specific example of the popup display for the second embodiment;

FIG. 15 illustrates another specific example of the popup display for the second embodiment;

FIG. 16 is a flowchart showing a specific example of the advertisement assessment processing for the second embodiment;

FIG. 17 is a block diagram showing a configuration example of the advertising expression assessment device and terminal device for the third embodiment;

FIG. 18 illustrates a specific example of the web Ad Video Site URL input screen for the third embodiment;

FIG. 19 illustrates a specific example of the advertising expression assessment result screen for the third embodiment;

FIG. 20 illustrates a specific example of the popup display for the third embodiment;

FIG. 21 illustrates another specific example of the popup display for the third embodiment;

FIG. 22 is a flowchart showing a specific example of the advertisement assessment processing for the third embodiment;

FIG. 23 illustrates a specific example of the advertising expression assessment result screen for the first variation;

FIG. 24 illustrates a specific example of the advertising expression assessment result screen for the second variation.

### DETAILED DESCRIPTION OF THE PREFERRED EMBODIMENT

### First Embodiment

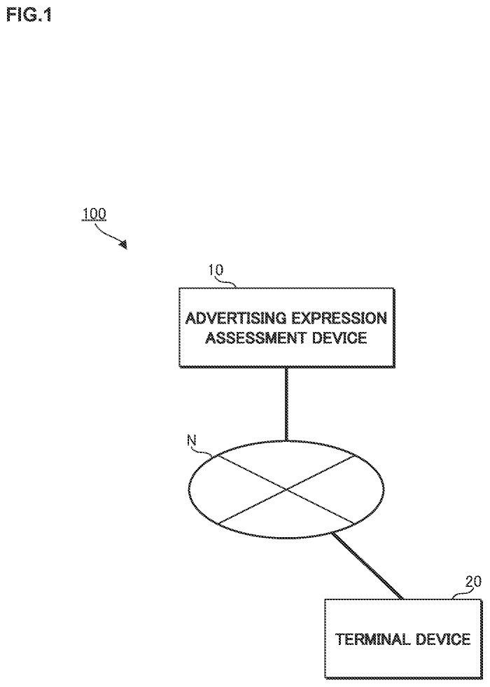

The first embodiment of the present invention is described below with reference to the drawings. The first embodiment illustrates an advertising expression assessment system 100 equipped with the advertising expression assessment device 10 of the present invention. FIG. 1, shows the configuration of advertising expression assessment system 100 for the first embodiment. The advertising expression assessment system 100 shown in FIG. 1 is equipped with an advertising expression assessment device 10 and a terminal device 20.

The advertising expression assessment system 100 displays a list of obtained advertising expressions and their usage acceptability for each country. The advertising expression assessment device 10 of this embodiment determines the usage acceptability of each advertising expression for every country based on the advertising review guidelines (hereinafter simply referred to as “advertising review guidelines”), and can display the results as a list on the terminal device 20. Thus, by listing the usage acceptability of the advertising expressions obtained from terminal device 20 for each country, it is possible to discern at a glance which countries the advertising expressions can be used in and which they cannot.

The case in which the advertising expression assessment device 10 is configured as a server computer with the terminal device 20 as a client is illustrated. The advertising expression assessment device 10 may be configured for distributed processing by multiple units, or by multiple virtual machines on a single server device. The advertising expression assessment device 10 may also be configured on a personal computer, or on a cloud server. The advertising expression assessment device 10 and the terminal device 20 are configured to communicate with each other via a network N such as the Internet.

Terminal device 20 is an information processing device used by the user. Terminal device 20 is, for example, a portable terminal such as a smartphone, tablet, personal digital assistant (PDA), desktop personal computer, or notebook personal computer. By entering information (e.g., words, phrases, URLs: Uniform Resource Locator, etc., including the advertising expression) on the terminal device 20, the usage acceptability of that advertising expression in each country is displayed in a list. Although the example shows one terminal device 20 connected to the network N, two or more terminal devices 20 may be connected.

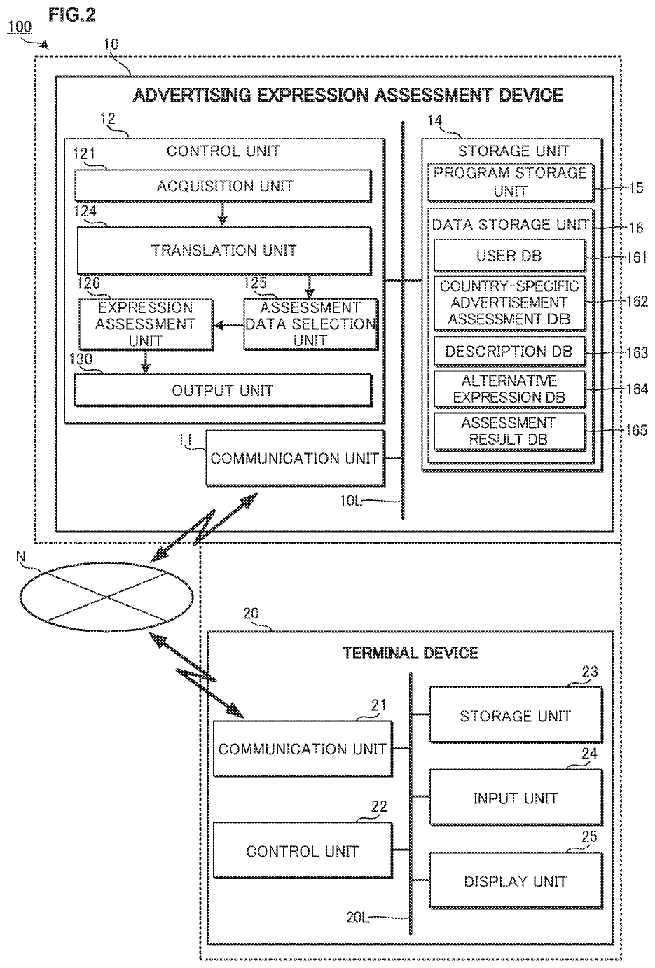

FIG. 2 is a block diagram showing specific configuration examples of the advertising expression assessment device 10 and terminal device 20 shown in FIG. 1. As shown in FIG. 2, the advertising expression assessment device 10 has a communication unit 11, a control unit 12, and a storage unit 14. The communication unit 11, control unit 12, and storage unit 14 are each connected to the bus line 10L and can mutually exchange information (data).

The communication unit 11 is wired or wirelessly connected to the network N and transmits and receives information (data) to and from the terminal device 20. The communication unit 11 functions as a communication interface for the Internet or an intranet, for example, using TCP/IP, Wi-Fi (registered trademark), or Bluetooth (registered trademark).

The control unit 12 comprehensively controls the entire advertising expression assessment device 10. The control unit 12 is composed of an integrated circuit such as an MPU (Micro Processing Unit). The control unit 12 is equipped with a CPU (Central Processing Unit), RAM (Random Access Memory), and ROM (Read Only Memory). The control unit 12 executes various processes by loading necessary programs into the ROM and executing the programs with the RAM as the work area.

The storage unit 14 is an example of a storage medium (a computer readable tangible storage medium) that stores various programs executed by the control unit 12 and data used by these programs. The storage unit 14 consists of a storage device such as a hard disk, optical disk, or magnetic disk. The configuration of the storage unit 14 is not limited to these, and the storage unit 14 may be configured with RAM, flash memory, or other semiconductor memory. For example, the storage unit 14 can be configured with an SSD (Solid State Drive).

The storage unit 14 includes program storage unit 15 and data storage unit 16. The program storage unit 15 stores various programs executed by the control unit 12. The control unit 12 reads necessary programs from the program storage unit 15 and executes various processes.

The data storage unit 16 stores user DB 161 (user database), country-specific advertisement assessment DB 162 (country-specific advertisement assessment database), description DB 163 (description database), alternative expression DB 164 (alternative expression database), assessment result DB 165 (assessment result database) and others. The user DB 161 includes pre-registered user IDs, company names, names etc. The user DB 161 is not limited to this, and may include user's address, department, gender, and so on.

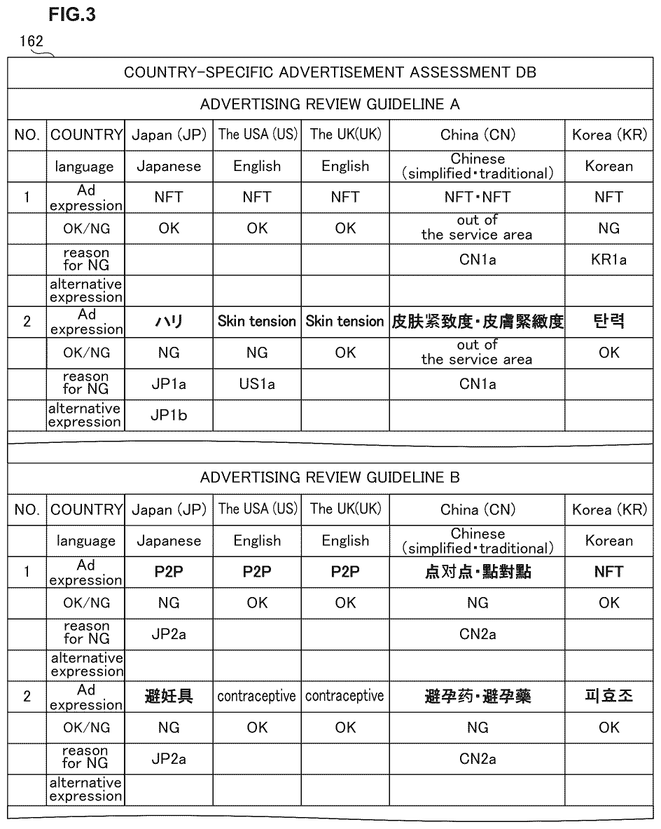

FIG. 3 shows a specific example of the country-specific advertisement assessment DB 162. The country-specific advertisement assessment DB 162 stores assessment data to assess the usage acceptability of advertising expressions for each country. Specifically, as shown in FIG. 3, for example, in the country-specific advertisement assessment DB, stores assessment data for the countries subject to assessment (Japan (JP), the United States (US), the United Kingdom (UK), China (CN), South Korea (KR), etc.), including the usage acceptability of advertising expression (OK or Not OK) for each country. For example, as shown in FIG. 3, the assessment data of the present embodiment is data that collects advertising expressions (words, phrases, etc.) that are Not OK (not acceptable for use) in either countries for each of several advertising review guidelines. Thus, as one can assess the usage acceptability of an advertising expression for each country for each advertising review guideline, determining an advertising review guideline that will pass the advertising review for a country becomes easier. Thus, the country-specific advertising assessment DB 162 constitutes a storage unit that stores assessment data for assessing the usage acceptability of advertising expressions for each of the countries based on the advertising review guidelines.

The assessment data shown in FIG. 3, country-specific advertising assessment DB 162, stores the results obtained by comparing multiple advertising review guidelines to determine whether an advertising expression that is Not OK for use in one of the countries is also Not OK for use in other countries. For instance, if an advertising expression that is Not OK in Japan is acceptable in the United States according to advertising review guidelines, then it is assumed to be OK (acceptable) in the United States. The advertising expressions in FIG. 3 include the notation in the language of that country and the type of language.

The advertising expressions in FIG. 3 are associated with the OK/Not OK types (Not OK for use, OK for use, out of service area, etc.), Not OK reasons (reason for Not OK), alternative expressions, etc., for each advertising review guideline. An advertising review guideline is, for example, an advertising review guideline for an ad network (Ad Network). An ad network is a system that collects multiple advertising media (websites, social media, blogs, etc.) to create an advertisement distribution network, and collectively distributes advertisements to these media.

Each advertisement network has its own advertising review guidelines, and the content of the advertising review guidelines differs depending on the country of destination. This is because laws and regulations and cultures differ from country to country. The advertising review guidelines also suggest advertising expressions that may not be used depending on the laws and regulations governing misleading labeling in each country and culture. For example, Japanese laws and regulations include the Act on Securing Quality, Efficacy and Safety of Pharmaceuticals and Medical Devices (hereinafter referred to as the Pharmaceuticals and Medical Devices Act), the Act against Unjustifiable Premiums and Misleading Representations (hereinafter referred to as Premiums and Representations Act), Pharmaceutical Affairs Law and other laws (including laws, government ordinances, and ministerial ordinances), Labor Standards Law, etc. Such advertising review guidelines include, for example, Amazon (registered trademark) AD, Facebook (registered trademark) AD, Google (registered trademark) AD, Instagram (registered trademark) AD, TikTok (registered trademark) AD, Yahoo (registered trademark) AD, and YouTube (registered trademark) AD. The advertising review guidelines are not limited to these guidelines, but may be other guidelines established based on the laws and cultures of each country.

The advertising expressions not permissible in the advertising review guidelines vary from country to country, and also differ depending on the type of ad network (e.g., Yahoo (registered trademark) AD, TikTok (registered trademark) AD, etc.). For example, Ad review guideline A in FIG. 3 is based on Yahoo (registered trademark) AD, and Ad review guideline B is based on TikTok (registered trademark) AD. Then, FIG. 3 shows that, for example, “contraceptive” as an advertising expression is Not OK in Japan and China for TikTok (registered trademark) AD, while it is OK in the United States, the United Kingdom, and South Korea. In addition, the use of “NFT” as an advertising expression in Yahoo (registered trademark) AD is OK in Japan, the United States, and the United Kingdom, but it is Not OK in South Korea, and indicates that it is outside the service area of Yahoo (registered trademark) AD in China. This kind of country-specific advertising assessment DB, helps to determine usage acceptability of advertising expressions for each advertising review guideline for each country.

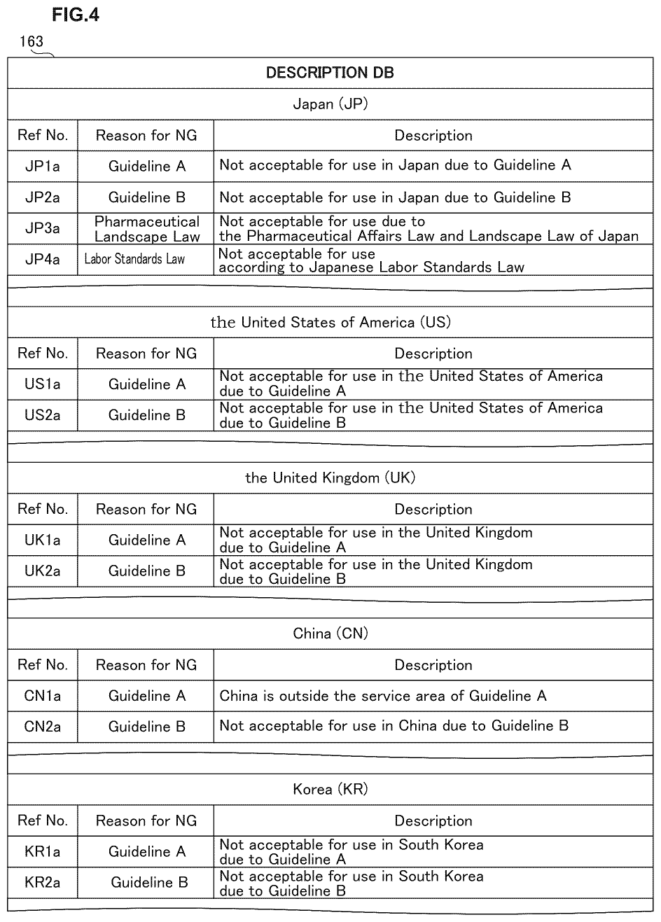

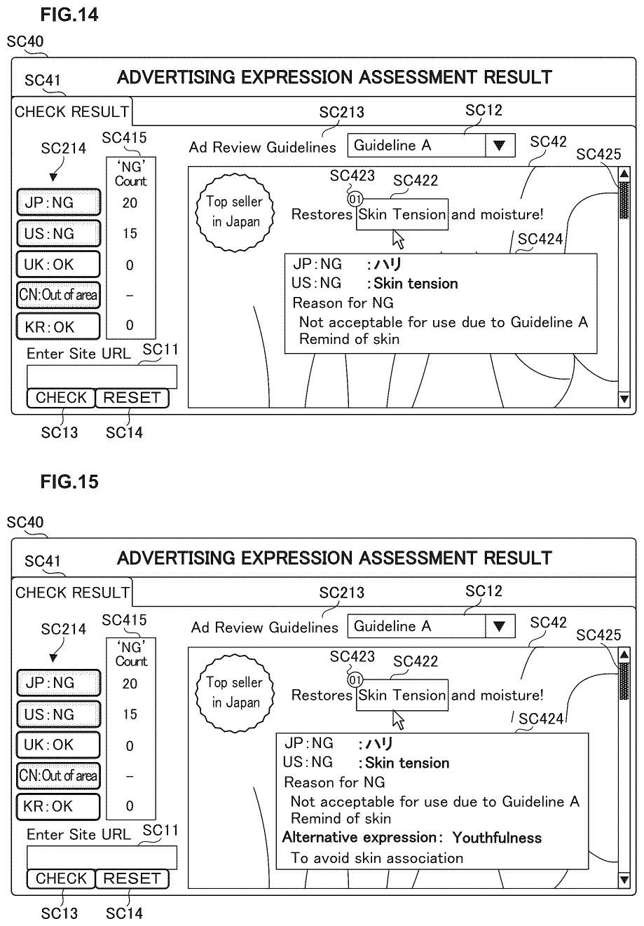

FIG. 4 shows a specific example of the Description DB 163. The Description DB 163 stores descriptions including reasons for Not OK of an advertising expression. As shown in FIG. 4, the Description DB 163 associates, a description and a reference number that are reasons for the Not OK for an advertising expression for each country. It should be noted that, as shown in FIG. 4, not only the description, but also its Not OK premise, etc. may be associated with the advertising expression. Although not shown, the Description DB 163 may have a remark column. The remarks column stores, for example, detailed reasons based on laws and regulations or culture. For example, for the advertising expression “Skin Tension”, “Remind of skin” may be stored in the remarks column, and it may be displayed in a pop-up SC42 as shown in FIG. 14 below. The description in the Description DB163 can be associated with the reasons for Not OK columns in other databases (the country-specific advertising assessment DB162, the assessment result DB165) by reference number. For example, in the country-specific advertisement assessment DB162 in FIG. 3, “contraceptive” as an advertising expression is Not OK for use in Japan, and Not OK reason column states “JP2a”, therefore, that Not OK reason is the description for “JP2a” in FIG. 4 (not acceptable for use in Japan according to Guideline B).

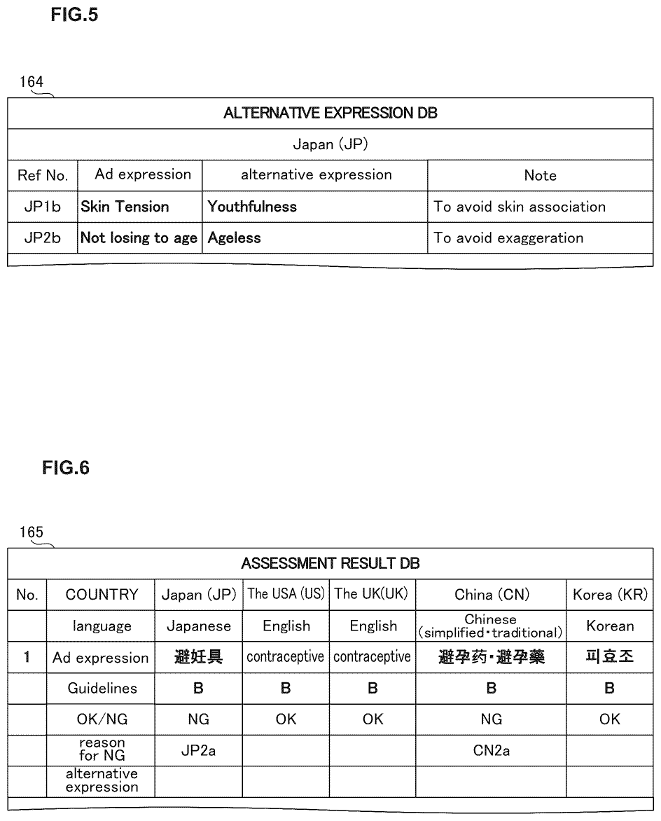

FIG. 5 shows a specific example of the alternative expressions DB 164. The alternative expressions DB 164 stores alternative expressions for advertising expressions that are Not OK for use. As shown in FIG. 5, the alternative expressions DB 164 associates country-wise advertising expressions that are Not OK with the alternative expressions and reference numbers. As shown in FIG. 5, these are not limited to alternative expressions, but warnings and other information about them may also be associated with the alternative expressions. FIG. 6, alternative expression DB 164, exemplifies some of the alternative expressions for advertising expressions in Japan, but it may also store alternative expressions for advertising expressions in other countries. These alternative expressions can be associated with alternative expressions column in other databases (the country-specific advertising assessment DB 162, the assessment result DB 165) according to the reference numbers. For example, in the country-specific advertisement assessment DB162 in FIG. 3, “skin tension” as an advertising expression is Not OK for use in Japan, and its alternative expression column states “JP1b”, therefore, that alternative expression becomes “youthfulness” for “JP1b” in FIG. 4.

FIG. 6 shows a specific example of the assessment result DB 165. The assessment result DB 165 stores the assessment results of the obtained advertising expression. Based on the data stored in this assessment result DB 165, the display data described below is generated. FIG. 6 shows an example of storing the assessment result of one advertising expression “contraceptive”. However, the present invention is not limited to this example, but when multiple advertising expressions included in web advertisements are assessed at a time, the assessment results of these multiple advertising expressions may be sequentially numbered and stored.

The control unit 12 in FIG. 2 includes an acquisition unit 121, a translation unit (translation acquisition unit) 124, an assessment data selection unit 125, an expression assessment unit 126 and an output unit 130. Each component of the control unit 12 may be configured with a physical circuit, or with a program executable by the CPU. The configuration of the control unit 12 is not limited to that shown in FIG. 2. The acquisition unit 121 obtains an advertising expression from terminal device 20 via communication unit 11. The acquisition unit 121, for example, obtains advertising expressions from information (words, phrases etc.) input from an input screen on an advertising expression assessment service website that can be displayed on the browser of the terminal device 20. This advertising expression assessment service site is a website that provides the advertising expression assessment service according to the present invention. The acquisition unit 121 obtains the type of advertising review guideline used in assessing advertising expressions from the terminal device 20 via the communication unit 11. The acquisition unit 121 obtains the type of advertising review guideline from the information (Ad review guideline A, Ad review guideline B, etc.) input from the above input screen of a website displayed on a browser on the terminal device 20.

The translation unit 124 is, a unit that obtains language expressions that are translated into the languages of respective countries for advertising expressions obtained in acquisition unit 121. Specifically, the translation unit 124, is a unit that translates the advertising expressions obtained in acquisition unit 121 into the linguistic expression for respective countries and obtains linguistic expressions for each country. Translation of the advertising expression may be done using the translation engine provided in the advertising expression assessment device 10, or using the translation engine of an external device. A translation engine of an external website may also be used for translation of the advertising expressions. It should be noted that it is not always necessary to acquire the translated advertising expressions in the language expressions of respective countries. For example, since the assessment data of the country-specific advertising assessment DB 162 stores advertising expressions in the language of each country, the translation unit 124 may use the assessment data to acquire the language expression for each country. For example, if the advertising expression obtained by the acquisition unit 121 is in Japanese, and if there is a Japanese advertising expression in the assessment data of the country-specific advertising assessment DB 162, then, language expressions in English, Chinese, Korean, for that advertising expression can also be obtained.

The assessment data selection unit 125 selects assessment data based on the type of advertising review guideline obtained by the acquisition unit 121. The assessment data selection unit 125 selects assessment data for the advertising review guideline obtained by the acquisition unit 121 from the country-specific advertisement assessment DB 162. For example, if the type obtained by the acquisition unit 121 is Ad review guideline B, then the assessment data of Ad review guideline B is selected from the country-specific advertisement assessment DB 162.

The expression assessment unit 126 determines whether each of the advertising expressions translated by the translation unit 124 is acceptable for use in each country, based on the assessment data. The expression assessment unit 126 determines the usage acceptability (Not OK or OK) of an advertising expression for each country based on the assessment data selected by the assessment data selection unit 125 (for example, the assessment data of examination guideline B), and stores these results in the assessment result DB 165.

The output unit 130 outputs display data listing the usage acceptability (Not OK or OK) of the aforementioned advertising expressions for each country. The output unit 130 generates and outputs this display data based on the assessment results in the assessment result DB 165. The display data here is intended for display on the advertising expression assessment service site. Consequently, on the advertising expression assessment service site displayed by the browser of terminal device 20, a list is shown indicating the usage acceptability of that advertising expression for each country. This allows for a quick determination, at a glance, of the countries where the advertising expression can or cannot be used.

Next, a configuration example of terminal device 20 will be described with reference to FIG. 2. The terminal device 20 shown in FIG. 2 is equipped with a communication unit 21, a control unit 22, a storage unit 23, an input unit 24, and a display unit 25. The communication unit 21, control unit 22, storage unit 23, input unit 24, and display unit 25 are each connected to the bus line 20L and can mutually exchange information (data).

The communication unit 21 is wired or wirelessly connected to the network N and transmits and receives information (data) to and from the advertising expression assessment device 10. The communication unit 21 functions as a communication interface for the Internet or an intranet, for example, using TCP/IP, Wi-Fi (registered trademark), or Bluetooth (registered trademark).

The control unit 22 comprehensively controls the entire terminal device 20. The control unit 22 is composed of an integrated circuit such as an MPU (Micro Processing Unit). The control unit 22 is equipped with a CPU (Central Processing Unit), RAM (Random Access Memory), and ROM (Read Only Memory). The control unit 22 executes various processes by loading necessary programs into the ROM and executing the programs with the RAM as the work area.

The storage unit 23 includes program storage unit and data storage unit. The program storage unit functions as a storage medium (a computer readable tangible storage medium) that stores multiple application programs executed by the control unit 22. The storage unit 23 may consist of a hard disk or semiconductor memory such as flash memory. For example, the storage unit 23 can be configured with an SSD (Solid State Drive).

The input unit 24 includes a keyboard, a mouse, etc., and receives an operation input from the user, and transmits a control signal corresponding to the operation content to the control unit 22. The input unit 24 may have a touch panel. The display unit 25 is a liquid crystal display, an organic EL display, etc., and displays various information according to instructions from the control unit 22. The display unit 25, for example, displays a website on a browser, and displays a word input screen SC10 and an advertising expression assessment result display screen SC20, described below, based on the display data of the advertising expression assessment device 10.

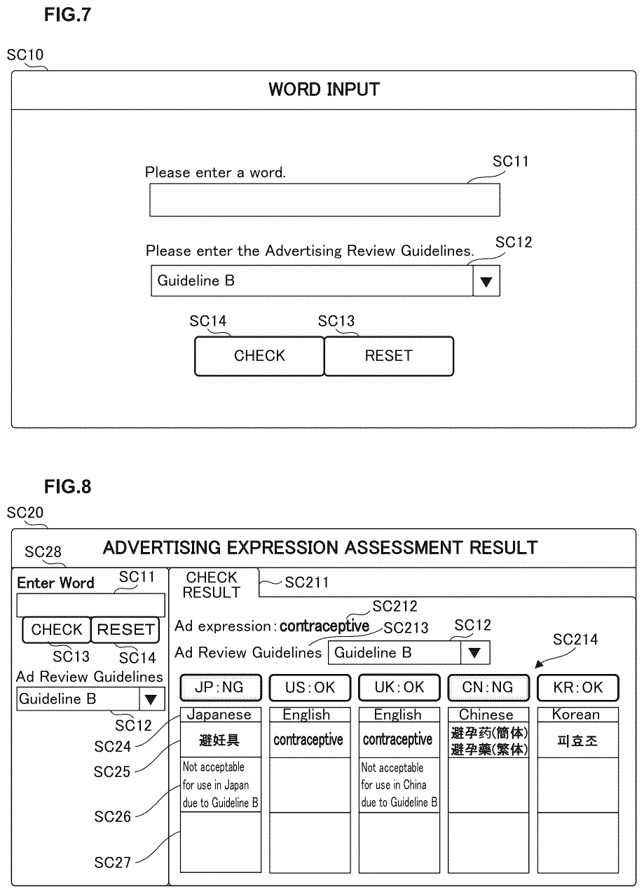

FIG. 7 shows the word input screen configuration as an example of the input screen displayed on the display unit 25. FIG. 7—word input screen SC10, displays first input field SC11 for entering a word or phrase, a second input field SC12 for entering the type of advertising review guideline, a check button SC13 to start assessment of the advertising expression, and a reset button SC14 to reset the input. As shown in FIG. 7, the second input field SC12 is designed to be input using a pull-down menu. Instead of using the pull-down menu, the type of advertising review guideline may be directly input, or by using radio buttons.

Next, FIG. 8 shows an example configuration of the assessment result display screen SC20 for advertising expressions, shown on display unit 25. The assessment result display screen SC20 includes the check result field SC211, which displays the assessment results. The check result field SC211 comprises the advertising expression display field SC212, the advertising review guideline display field SC213, and the list of usage acceptability for each country SC214. The advertising expression display field SC212 shows the advertising expression entered in the first input field SC11 in FIG. 7. The advertising review guideline display field SC213 presents the type of advertising review guidelines entered in the second input field SC12 in FIG. 7. A pull-down menu similar to the second input field SC12 in FIG. 7 may be displayed in the advertising review guideline display field SC213 in FIG. 8. This facilitates the easy display of assessment results under different advertising review guidelines.

Each country usage acceptability list SC214 lists the acceptability of advertising expression for each country. Each country acceptability list SC214 displays, language type field SC24, official language of a country description field SC25, Not OK reason field SC26, alternative expression field SC27 for each country respectively. The language type field SC24 displays the language type of that country. For example, Japanese for Japan, English for the United States and the United Kingdom, Chinese for China, and Korean for South Korea. The Chinese language is displayed in both simplified and traditional Chinese, allowing for the determination of advertising expressions not only in mainland China, but also in special administrative regions such as Hong Kong and Taiwan. The official language of a country description field SC25 displays advertising expression translated to the official language of that country from the assessment result DB165. The Not OK reason field SC26 displays the description in the description DB163 associated with the Not OK reason of the assessment result DB165. The alternative expression field SC27 displays the alternative expression from the alternative expression DB164 associated with the alternative expression from the assessment result DB165.

FIG. 8 shows the assessment results when “contraceptive” is entered as the advertising expression in the first input field SC11 and review guideline B is entered in the second input field SC12. At a glance, the assessment results in FIG. 8 make it clear that the advertising expression “contraceptive” is Not OK (not acceptable for use) in Japan and China as per review guideline B, but is OK (acceptable) in the United States, the United Kingdom, and South Korea. This indicates that the advertising expression “contraceptive” can be used as is in the United States, the United Kingdom, and South Korea, but requires modification for use in Japan and China. Therefore, by only modifying the advertising expression in countries where it is Not OK (not acceptable for use), it becomes easier to pass the advertisement reviews in each country without needing comprehensive changes across all countries.

As shown in FIG. 8, a sidebar SC28 may be displayed on the assessment result display screen SC20. The sidebar SC28 may display a first input field SC11 to input the advertising expression, a second input field SC12 to input the type of advertising review guideline, a check button SC13 to start assessment of the advertising expression, and a reset button SC14 to reset the input. Note that the display screen is not limited to those shown in FIG. 7 and FIG. 8.

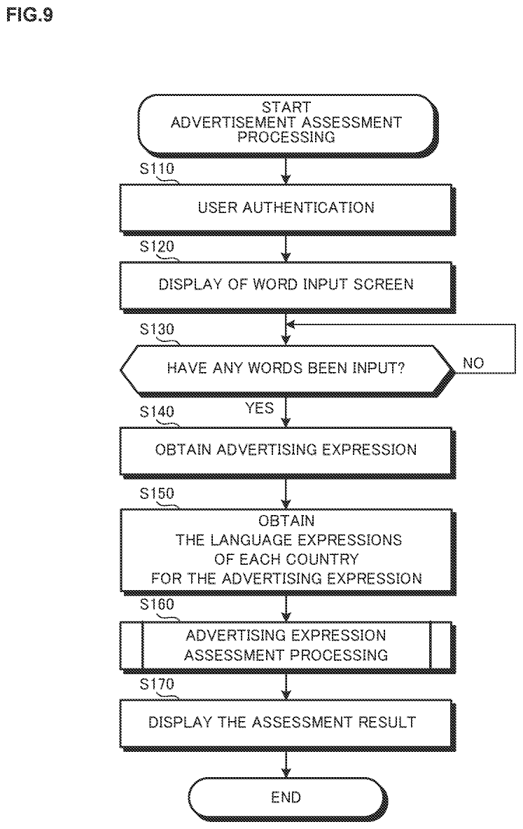

Next, the advertisement assessment process executed by the advertising expression assessment device 10 of the first embodiment will be explained with reference to FIG. 9. FIG. 9 is a flowchart showing a specific example of the advertisement assessment process of the first embodiment. The advertisement assessment process of the first embodiment is executed by the control unit 12 (acquisition unit 121, translation unit 124, assessment data selection unit 125, expression assessment unit 126, output unit 130, etc.) reading and executing the necessary programs from the program storage unit 15.

In the advertisement assessment process depicted in FIG. 9, the control unit 12 first executes user authentication in step S110. In user authentication, an ID and password input screen (not shown) is displayed on the terminal device 20. Once the ID and password are entered and the user is authenticated, in step S120, the control unit 12 displays a word input screen SC10, as shown in FIG. 7, on the terminal device 20. Then, in step S130, the control unit 12 determines whether a word has been input. Specifically, if a word and the type of advertising review guideline are entered and the check button SC13 is clicked, the control unit 12 proceeds to the processing of step S140.

In step S140, the control unit 12 obtains the advertising expression. Specifically, the acquisition unit 121 obtains the word entered in the first input field SC11 as the advertising expression. Additionally, the acquisition unit 121 also obtains the type of advertising review guideline entered in the second input field SC12.

Subsequently, in step S150, the control unit 12 obtains the language expressions of the advertising expression for each country. Specifically, the translation unit 124 translates the advertising expression obtained by the acquisition unit 121 into languages of various countries other than the language in which it was entered, thereby obtaining language expressions of the advertising expression for each country. For instance, if the advertising expression is input in Japanese, it is translated into other languages such as English, Chinese (simplified and/or traditional), and Korean. Similarly, if the advertising expression is input in English, it is translated into other languages such as Japanese, Chinese (simplified and/or traditional), and Korean.

Next, in step S160, the control unit 12 executes the advertising expression assessment processing. The advertising expression assessment processing involves determining the usage acceptability (Not OK or OK) of the advertising expression in each country.

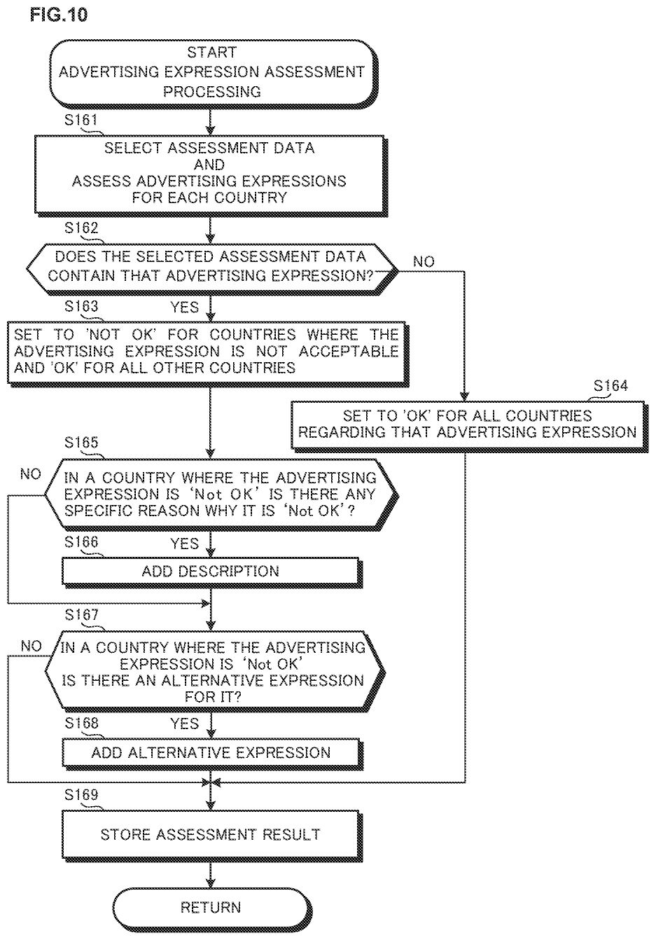

Now, a specific example of the flowchart of the advertising expression assessment processing is shown in FIG. 10. The advertising expression assessment processing, as shown in FIG. 10, is executed by the control unit 12 (the assessment data selection unit 125 and the expression assessment unit 126, etc.). First, in step S161, the assessment data selection unit 125 selects the appropriate assessment data for determining the advertising expression's usage acceptability in each country. Specifically, in step S161, the assessment data selection unit 125 selects the assessment data from the country-specific advertisement assessment DB 162 based on the type of advertising review guideline obtained by the acquisition unit 121. For instance, as shown in FIG. 7, if the type obtained is review guideline B, then the assessment data selection unit 125 selects the corresponding assessment data for review guideline B from the country-specific advertisement assessment DB 162 as shown in FIG. 3.

Next, the expression assessment unit 126, from steps S162 to S164, determines the usage acceptability of the advertising expression in each country based on the assessment data selected by the assessment data selection unit 125. Specifically, in step S162, the expression assessment unit 126 determines whether the advertising expression exists in the selected assessment data. For example, it determines whether the language expression of the advertising entered on the input screen in FIG. 6 exists in the selected assessment data. Additionally, it may also assess whether all the language expressions translated into various languages exist in the selected assessment data. This is because if any language expression of the advertising exists in the assessment data, it suggests that there is a possibility of it being Not OK (not acceptable) for use in some countries.

In step S162, if the expression assessment unit 126 determines that the advertising expression does not exist in the assessment data, then at step S164, it assumes that the advertising expression is OK (acceptable) for use in all countries. Without proceeding to steps S165 to S168, it stores the assessment results in the assessment results DB 165 at step S169.

Conversely, if the expression assessment unit 126 determines in step S162 that the advertising expression is in the selected assessment data, in that case, in step S163, that advertising expression is assessed as Not OK (not acceptable) for use in countries where the advertising expression is not acceptable, and as OK (acceptable) for use in other countries. For instance, if an advertising expression is found in the assessment data of Ad review guideline B as shown in FIG. 3, it is assessed as Not OK for use in countries where it is not acceptable, such as Japan and China, while it is assessed as OK for use in other countries, such as the United States, the United Kingdom, and South Korea.

Then, in step S165, the expression assessment unit 126 determines whether there is a reason for Not OK in a country where the advertising expression is Not OK. If the expression assessment unit 126 determines that there is a Not OK reason in step S165, it adds the Not OK reason to the assessment result in step S166. Specifically, the expression assessment unit 126 determines whether the Not OK reason column of the selected assessment data contains a reference number from description DB 163 as shown in FIG. 4. At this time, if the expression assessment unit 126 determines that there is a reference number in the Not OK reason column of the assessment data, it also adds the reference number to the Not OK reason in the assessment result. Thus, for example, the reference numbers JP2a and CN2a are added to the Not OK Reason column in FIG. 6. Conversely, in step S165, if the expression assessment unit 126 determines that there is no reason for Not OK in the country where the advertising expression is Not OK, it moves to the process of step S167.

In step S167, the expression assessment unit 126 determines whether there is an alternative expression for that advertising expression in the Not OK country. If the expression assessment unit 126 determines that there is an alternative expression in step S167, the alternative expression is added to the assessment result in step S168, and it moves to the process of step S169. Specifically, for instance, the expression assessment unit 126 determines whether there is a reference number in the alternative expression DB 164 in FIG. 5 in the alternative expression column of the selected assessment data. At this time, if the expression assessment unit 126 determines that there is a reference number in the alternative expression column of the assessment data, it also adds the reference number to the alternative expression column in assessment result. Conversely, in step S167, if the expression assessment unit 126 determines that there is no alternative expression in the country where the advertising expression is Not OK, it moves to the process of step S169. In step S169, the expression assessment unit 126 stores the above assessment result in the assessment result DB 165, terminates the series of advertising expression assessment process, and moves to the process of step S170 in FIG. 9.

Then, in step S170 in FIG. 9, the output unit 130 displays the assessment results on the terminal device 20. Specifically, the output unit 130 generates display data listing the usage acceptability of the advertising expression for each country from the assessment results in the assessment results DB 165 and displays it on the advertising expression assessment service site. Consequently, on the advertising expression assessment service site displayed by the browser of terminal device 20, for example, the assessment result display screen SC20, as depicted in FIG. 8, shows a list of the usage acceptability of advertising expressions for each country. Furthermore, the display data may also be shown by a dedicated application program on the terminal device 20. In such a case, a dedicated application program might be downloaded to the terminal device 20, and the terminal device 20 could use this program to receive display data from the communication unit 21 and display the assessment result display screen SC20 on its display unit 25.

Thus, in the first embodiment, when a word and the type of Ad review guideline are entered on the input screen SC10 and the check button is clicked, the entered word is acquired as an advertising expression. The usage acceptability of that advertising expression in each country is determined based on the assessment data of the entered Ad review guidelines. Subsequently, display data of the assessment result is generated and displayed on the terminal device 20. As a result, the terminal device 20 displays a list indicating the usage acceptability of the input advertising expression for each country. Therefore, it is possible to easily discern at a glance in which countries the advertising expression can be used and in which it cannot.

Furthermore, for each Ad review guideline, the assessment of the advertising expression is possible, and the display on the assessment result display screen SC40 indicates whether the advertising expression meets the advertising review standards of each country. Therefore, it is possible to immediately discern at a glance whether the advertising expression will satisfy and pass the advertising review of each country. While this embodiment illustrates entering a word on the input screen SC10, it is not limited to words; phrases, for example, may also be input. When a phrase is input to input screen SC10, the acquisition unit 121 obtains the phrase as an advertising expression.

### Second Embodiment

The second embodiment of the present invention is described below. In each of the embodiments illustrated below, components that have substantially the same functional structure will be marked with the same symbol to avoid redundancy. The first embodiment illustrates a case where by entering a word or phrase in the input screen, that word or phrase is obtained as an advertising expression. The second embodiment illustrates a case where by entering a URL of a web advertisement on the input screen, the words included in that web advertisement are extracted and obtained as an advertising expression.

The image displayed as a web advertisement contains several words, as shown in FIG. 14, which may be Not OK for use as an advertising expression in some countries. However, in the first embodiment, all the words in the web advertisement must be assessed individually, which is very time-consuming and labor intensive. Therefore, in the second embodiment, all words included in the web advertisement are extracted, multiple advertising expressions are obtained and assessed at once, and the assessment results are displayed for each word in the web advertisement. Thus, this can significantly save time and effort in determining the advertising expressions.

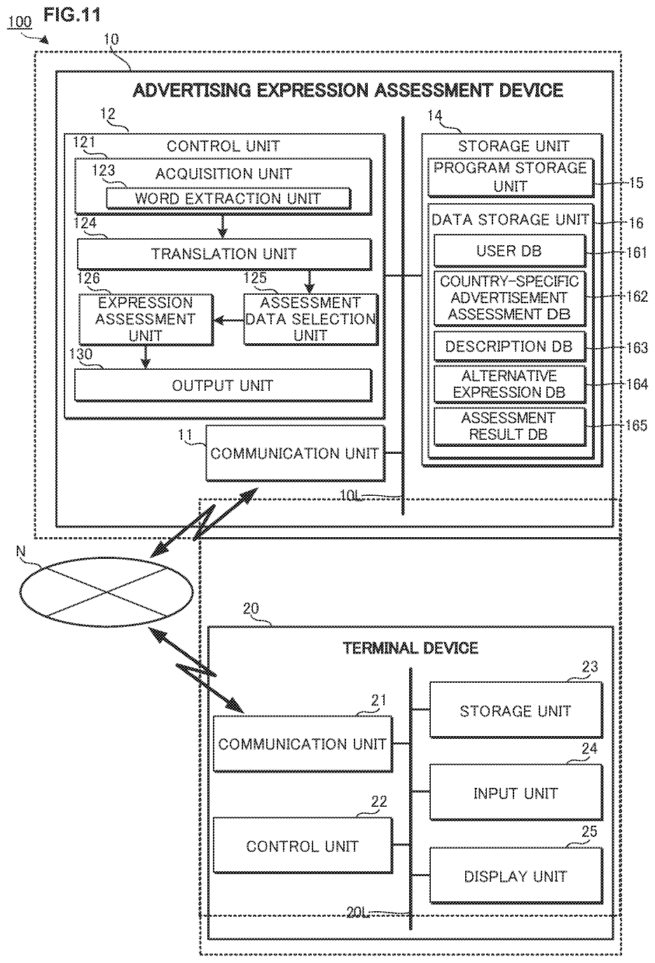

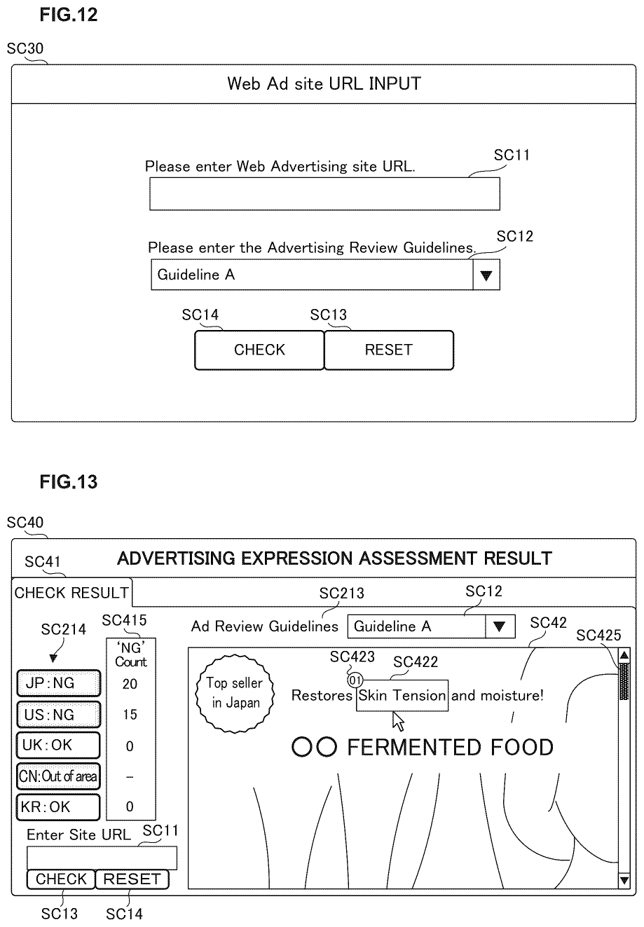

FIG. 11 is a block diagram showing a configuration example of the advertising expression assessment device and terminal device of the second embodiment, corresponding to FIG. 2. In FIG. 11, the acquisition unit 121 has a word extraction unit 123 which is different from FIG. 2. FIG. 12 shows a specific example of the web advertisement site URL input screen SC30 of the second embodiment, and corresponds to FIG. 7. The difference between FIGS. 12 and 7 is that the site URL is input instead of a word in the first input field SC11.

FIG. 13 through 15 show specific examples of the advertising expression assessment result display screen SC40 of the second embodiment, and correspond to FIG. 8. FIGS. 13 through 15 differ from FIG. 8 in that the check result field SC41 has a web advertisement site display field SC42 and a Not OK number display field SC415 instead of the sidebar SC28. As shown in FIG. 13, in the assessment result display screen SC40 of the second embodiment, the web advertisement of the input URL is displayed in the site display field SC42, and adds the highlighting SC422 to the advertising expressions included therein that have countries that are Not OK for use.

For the highlighting SC422, as shown in FIG. 13 for example, the advertising expression for countries where it is Not OK can be marked with a frame or its color can be changed. Additionally, as shown in FIG. 13, a number display SC423 can be added to the highlighting SC422. In FIG. 13, with the highlighting SC422 added to “Skin Tension”, it is possible to discern at a glance that there are countries where the use of “Skin Tension” is Not OK.

In FIG. 13-country-specific usage acceptability list SC214, when the cursor is hovered over as in a mouse-over, the usage acceptability of the advertising expression for each country is displayed. In FIG. 13, as the cursor is hovered over “Skin Tension” to which the highlighting SC422 is added, the usage acceptability list SC214 for the advertising expression “Skin Tension” for each country is displayed.

Next to the country-specific usage acceptability list SC214 in FIG. 13, the Not OK count display field SC415 is shown. The Not OK count display field SC415 indicates the number of Not OKs for each country. Here, the Not OK count refers to the number of advertising expressions that are Not OK for use in each country among the multiple expressions included in the web advertisement. According to FIG. 13, this web advertisement site includes 20 advertising expressions that are Not OK for use in Japan and 15 that are Not OK for use in the United States under Ad review guideline A. These Not OK counts include expressions that are Not OK for use in two or more countries, such as “Skin Tension” shown in FIG. 13.

As shown in FIG. 14, a pop-up display SC424 may appear when the cursor is hovered over the advertising expression. The pop-up display SC424 shows the countries where the expression is Not OK for use and the advertising expression expressed in the language of those countries. Additionally, as shown in FIG. 14, the Not OK reason may also be displayed in the pop-up display SC424. Furthermore, as shown in FIG. 14, a scroll bar SC425 can be displayed on the side of the site display field SC42, allowing the web advertisement to be scrolled. Moreover, as shown in FIG. 15, the pop-up display SC424 may also display alternative expressions.

The advertising review guideline display field SC213 is displayed on the advertising expression assessment result display screen SC40 of FIGS. 13 through 15 as in FIG. 8. A pull-down menu similar to the second input field SC12 in FIG. 8 may be displayed in this advertising review guideline display field SC213. This assessment result display screen SC40 may display a first input field SC11 to input the site URL similar to FIG. 12, a check button SC13 to start assessment of the advertising expression, and a reset button SC14 to reset the input. Note that the display screen is not limited to those shown in FIGS. 12 through 15.

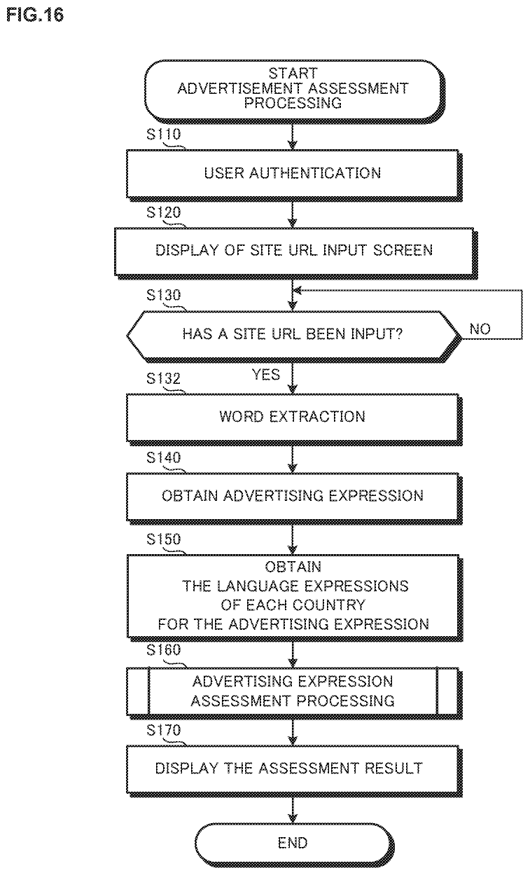

Next, the advertisement assessment process executed by the advertising expression assessment device 10 of the second embodiment will be explained with reference to FIG. 16. FIG. 16 is a flowchart showing a specific example of the advertisement assessment process of the second embodiment, corresponding to FIG. 9. The advertisement assessment process of the second embodiment is executed by the control unit 12 (acquisition unit 121, word extraction unit 123, translation unit 124, assessment data selection unit 125, expression assessment unit 126, output unit 130, etc.) by reading and executing the necessary programs from the program storage unit 15.

FIG. 16 differs from FIG. 9 in that the control unit 12 displays the site URL input screen SC30 in FIG. 12 in step S120. Another difference from FIG. 9 is that in step S130, the control unit 12 determines whether a site URL, rather than a word, is input in the first input field SC11 in FIG. 12. Specifically, when the control unit 12 determines that the site URL and the type of advertising review guideline have been input on the site URL input screen SC30, FIG. 12, and the check button SC13 has been clicked, the control unit 12 moves to the process of step S132.

Then, in step S132, the word extraction unit 123 extracts words from the web advertisement of the site URL, and in step S140, the acquisition unit 121 obtains one or more advertising expressions included in the web advertisement, which differs from FIG. 9. The word extracting unit 123 extracts words included in the web advertisement using machine-learned models or natural language processing, such as AI (artificial intelligence). Note that the method of extracting words included in web advertisements is not limited to this, and any method may be used. In step S150 of FIG. 16, each of the obtained one or more advertising expressions is translated into the language of each country, and step S160 of FIG. 16 is executed. Step S160 in FIG. 16 also executes the advertising expression assessment processing shown in FIG. 10. In the advertising expression assessment processing of the second embodiment, advertisement assessment processing is executed for all advertising expressions, and the assessment results are stored in the assessment result DB 165.

In step S170 of FIG. 16, the output unit 130 generates and outputs display data from the assessment results in the assessment result DB 165, resulting in the display of the assessment result display screen SC40 shown in FIG. 13 on the terminal device 20. The display data of the second embodiment includes the display of the web advertisement with highlighting on the advertising expression that has been determined not permitted for use in at least one country. This display of the web advertisement with the highlighted advertising expression is shown in the site display field SC42 in FIG. 13.

The display data of the second embodiment also includes data indicating whether that advertising expression acceptable for use in each country when the cursor is hovered over the advertising expression with the highlighted SC422. In FIG. 13, since the cursor is hovered over “Skin Tension” to which the highlighting SC422 is added, the usage acceptability list SC214 is displayed for the advertising expression “Skin Tension” for each country. FIG. 13 shows at a glance that “Skin Tension” is Not OK for use in Japan and the United States under Ad review guideline A, while it is OK for use in the United Kingdom and South Korea. Furthermore, in China, it can be seen that Ad review guideline A is out of the service area. China is outside the service area of Advertising Review Guideline A.

The display data of the second embodiment also includes data to display the number of advertising expressions not acceptable for use in each country (for example, the number of Not OKs in FIG. 13) among multiple advertising expressions included in the web advertisement. FIG. 13 shows that this web advertisement site contains 20 advertising expressions that are Not OK for use in Japan and 15 advertising expressions that are Not OK for use in the United States under Ad review guideline A. If the advertising expressions determined as Not OK are modified to become acceptable and re-assessed, the number of Not OKs in FIG. 13 will also decrease. This makes it easy to determine how many advertising expressions need to be modified to pass the advertising review under Ad review guideline A.

The display data of the second embodiment also includes data to display a pop-up display SC424 that, when the cursor is placed over the advertising expression with highlighted, shows at least the country in which the advertising expression is Not OK (not acceptable) for use. The pop-up display SC424 may include Not OK reasons (see FIG. 14) or alternative expressions (see FIG. 15) for that advertising expression. Thus, this makes it easier to modify the advertising expression that has been determined to be Not OK for use.

According to the second embodiment, by extracting all the words included in a web advertisement, multiple advertising expressions in a web advertisement can be obtained and assessed. Then, the assessment result can be displayed for each word in the Web advertisement. Thus, according to the second embodiment, the terminal device 20 displays a list of the usage acceptability of the advertising expressions included in the Web advertisement for each country, so that one can see at a glance the advertising expression usable for each country on the web advertisement. Moreover, since all the advertising expressions included in web advertising sites can be determined at once, the time and effort required to determine advertising expressions can be significantly reduced.

### Third Embodiment

The third embodiment of the present invention is described below. The second embodiment illustrates the web advertisement containing an advertising expression is an image, but in the third embodiment, the web advertisement containing an advertising expression is a video. In recent years, video distribution of web advertisements has increased significantly. This web advertising video site may also contain advertising expressions that are Not OK for use in some countries. Hence, in the third embodiment, illustrates a case where, by entering the video URL of web advertisement on the input screen SC11, the words included in that web advertisement video are extracted and obtained as an advertising expression.

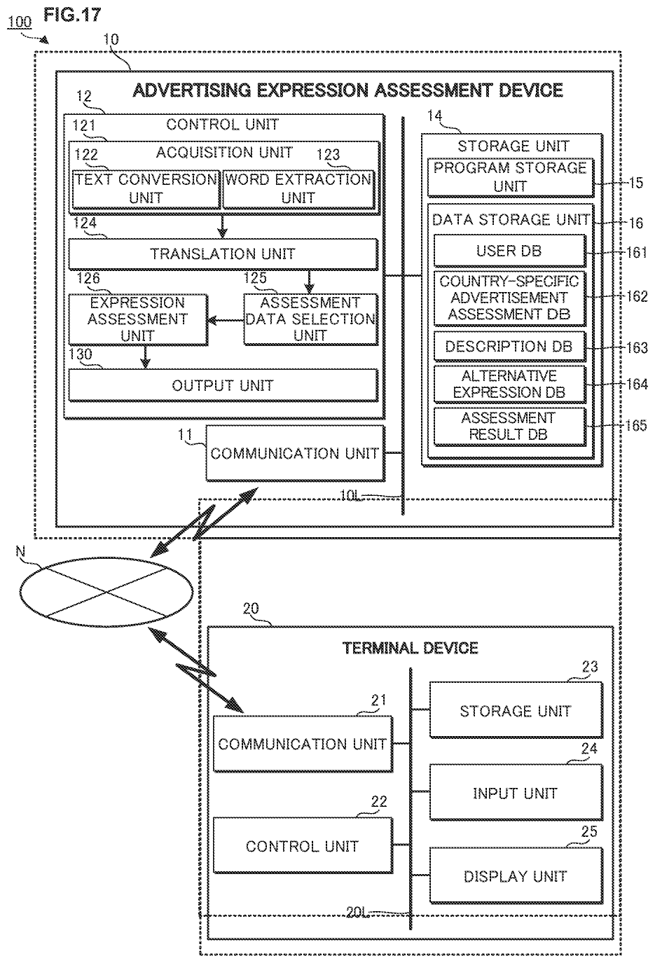

FIG. 17 is a block diagram showing a configuration example of the advertising expression assessment device and terminal device of the second embodiment, corresponding to FIG. 11. In FIG. 17, the difference from FIG. 11 is that the acquisition unit 121 has a text conversion unit 122. If the web is a video site, convert the audio to text and then extract the words. The text conversion unit 122 converts the audio included in the video of the web advertisement into text using a learned model based on machine learning, such as AI (artificial intelligence). Note that the text conversion method is not limited to this, for example, an engine or site that converts speech to text may be used. Alternatively, data obtained by converting audio to text on a video site may be imported. When audio is captured as text-converted data, the text conversion unit 122 may not be provided.

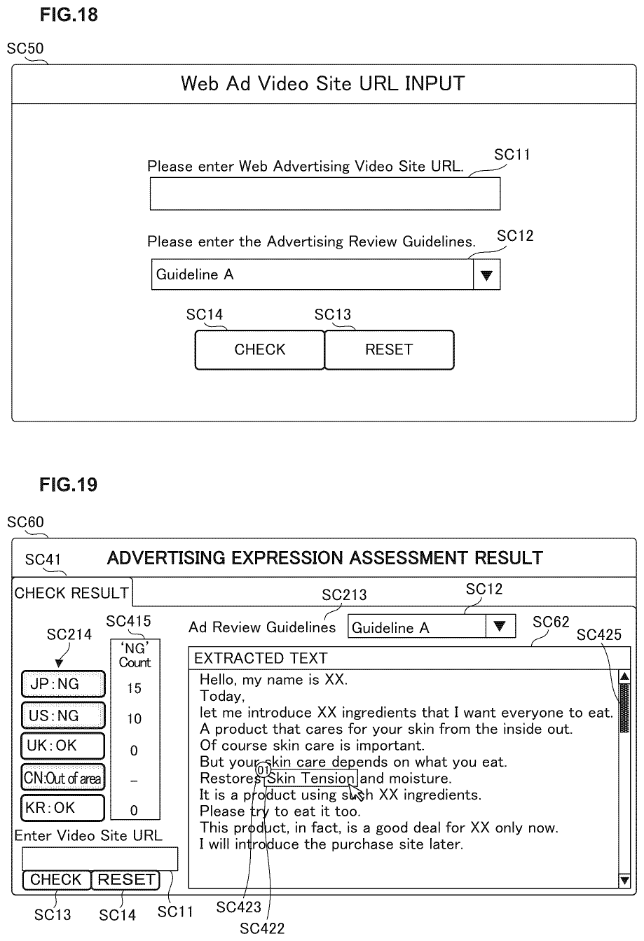

FIG. 18 shows a specific example of the web advertisement video site URL input screen SC50 of the third embodiment, and corresponds to FIG. 12. The difference between FIG. 18 and FIG. 12 is that the video site URL is input in the first input field SC11.

FIGS. 19 through 21 show specific examples of the advertising expression assessment result display screen SC60 of the third embodiment, and correspond to FIGS. 13 through 15. FIGS. 19 through 21 differ from FIGS. 13 through 15 is that instead of the site display field SC42, the text extraction sentence display field SC62 is displayed. In the text extraction display field SC62, text data of audio included in the video or text embedded in the video is displayed as text. As shown in FIG. 19, in the assessment result display screen SC60 of the third embodiment, the web advertisement of the input video site URL is displayed in text in the text extraction sentence display field SC62, and the advertising expressions included therein that have countries that are Not OK for use are highlighted SC422.

As for highlighting SC422 of the third embodiment, as shown in FIG. 19 as an example, the advertising expression can either be marked with a frame or can change the color for those countries where the expression is Not OK for use. Further, as shown in FIG. 19, a number display SC423 may be added to the highlight display SC422. In FIG. 19, the textual representation “Skin Tension” is marked with a highlight display SC422. Thus, even if this advertising expression “Skin Tension” is expressed by voice in the video, it is displayed in text, making it clear at a glance that there are countries where the use of the advertising expression is Not OK.

In FIG. 19—country-specific usage acceptability list SC214, when the cursor is hovered like the mouse-over, displays the usage acceptability of the advertising expression for each country. In FIG. 19, since the cursor is hovered over “Skin Tension” which is highlighted SC422, the usage acceptability list SC214 is displayed for the advertising expression “Skin Tension” for each country.

Not OK count display field SC415 is displayed next to the each country list SC214 in FIG. 19. The Not OK count display field SC415 displays the Not OK number for each country. The Not OK count here is the number of advertising expressions that are Not OK for use in each country among multiple advertising expressions included in the web advertisement. FIG. 19 shows that this web advertisement site contains 15 advertising expressions that are Not OK for use in Japan and 10 advertising expressions that are Not OK for use in the United States under Ad review guideline A. These Not OK counts include those that are Not OKs for use in two or more countries, such as “Skin Tension” in FIG. 19.

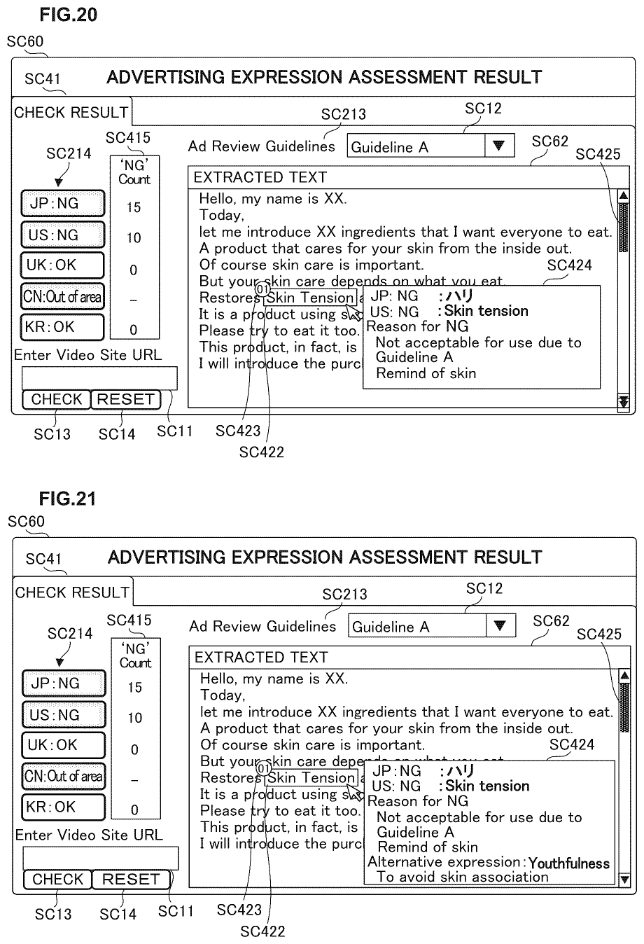

As shown in FIG. 20, a pop-up display SC424 may appear when the cursor is hovered over the advertising expression. Pop-up display SC424 displays the country where Not OK for use and the advertising expression expressed in the language of that country. Further, as shown in FIG. 20, the Not OK reason may also be displayed in the pop-up display SC424. Further, as shown in FIG. 20, a scroll bar SC425 may be displayed on the side of the text extraction sentence display field SC62 to allow the display of the text extraction sentence to be scrolled. Furthermore, as shown in FIG. 21, the pop-up display SC424 may also display alternative expressions.

The advertising review guideline display field SC213 is displayed on the advertising expression assessment result display screen SC60 of FIGS. 19 through 21 as in FIGS. 13 through 15. A pull-down menu similar to the second input field SC12 in FIG. 8 may be displayed in this advertising review guideline display field SC213. This assessment result display screen SC40 may display a first input field SC11 to input the video site URL similar to FIG. 18, a check button SC13 to start assessment of the advertising expression, and a reset button SC14 to reset the input. Note that the display screen is not limited to those shown in FIGS. 18 through 21.

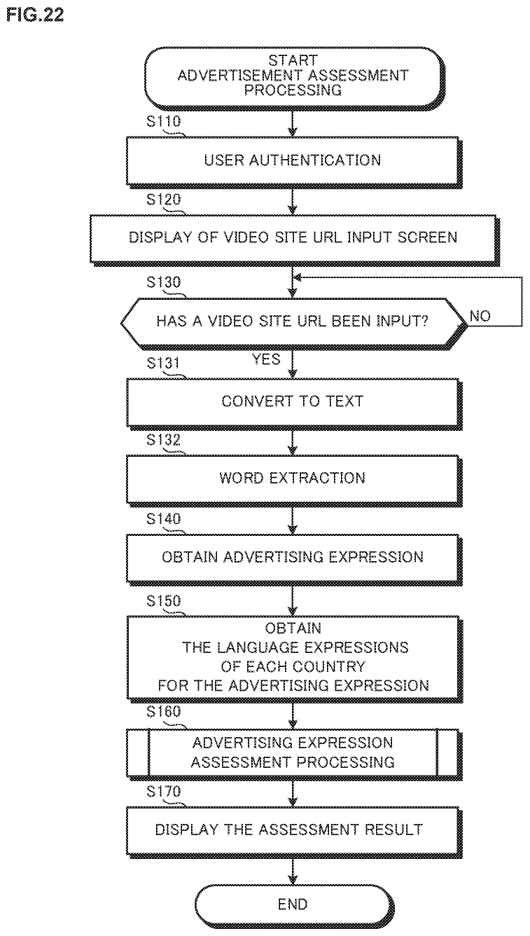

Next, the advertisement assessment processing executed by advertising expression assessment device 10 of the third embodiment will be explained with reference to FIG. 22. FIG. 22 is a flowchart showing a specific example of the advertisement assessment processing of the third embodiment, corresponding to FIG. 16. The third embodiment of the advertisement assessment processing is executed by the control unit 12 (acquisition unit 121, text conversion unit 122, word extraction unit 123, translation unit 124, assessment data selection unit 125, expression assessment unit 126, output unit 130, etc.) by reading the necessary program from the program storage unit 15.

FIG. 22 differs from FIG. 16 in that the control unit 12 displays the video site URL input screen SC50 in FIG. 18 in step S120. Another difference from FIG. 16 is that in step S130, the control unit 12 determines whether a video site URL is input in the first input field SC11 in FIG. 16. Specifically, when the control unit 12 determines that the video site URL and the type of advertising review guideline have been input on the video site URL input screen SC50 in FIG. 18, and the check button SC13 has been clicked, the control unit 12 moves to the process of step S131.

Then, in step S131, the text conversion unit 122 converts voice to text from the web advertisement of that video site URL, in step S132, the word extraction unit 123 extracts words from the text web advertisement, and in step S140, the acquisition unit 121 obtains one or more advertising expressions in the text web advertisement. This differs from FIG. 16. The word extracting unit 123 extracts words included in the textual web advertisement using machine-learned models or natural language processing, such as AI (artificial intelligence). Note that the method of extracting words included in web advertisements is not limited to this, and any method may be used. In step S150 of FIG. 22, each of the obtained one or more advertising expressions is translated into the language of each country, and step S160 of FIG. 22 is executed. Step S160 in FIG. 22 also executes the advertising expression assessment processing shown in FIG. 10. In the advertising expression assessment processing of the third embodiment, advertisement assessment processing is executed for all advertising expressions, and the assessment results are stored in the assessment result DB 165. In step S170 of FIG. 22, the output unit 130 generates and outputs display data from assessment results in the assessment result DB 165, so that the assessment result display screen SC60 shown in FIG. 19 is displayed on the terminal device 20.

The display data of the third embodiment also includes data indicating whether that advertising expression acceptable for use in each country when the cursor is hovered over the advertising expression with the highlighting SC422. The display data of the third embodiment also includes data to display the number of advertising expressions not permitted for use in each country (for example, the number of Not OKs in FIG. 19) among multiple advertising expressions included in the web advertisement. The display data of the second embodiment also includes data to display a pop-up display SC424 that, when the cursor is hovered over the advertising expression with highlighted, displays at least the country in which the advertising expression is Not OK (not acceptable) for use. The details of these are the same as those of the second embodiment, so the detailed description is omitted here.

According to this third embodiment, even if the web advertisement is a video, the advertising expression can be obtained from the voice-text data included in the video. Therefore, it can be assessed similarly to when the web advertisement is not a video (such as text or images), like in the second embodiment. This enables us to display the usage acceptability of the advertising expressions for each country on the web advertisement, making it easy to discern at a glance in which countries the advertising expression can be used and in which it cannot, regardless of whether the advertisement is a video or not. Moreover, since it is possible to assess all the advertising expressions included in web video advertisements at once, the time and effort required for the assessment can be significantly reduced.

### Variation

The present invention is not limited to the embodiments described above, but can be applied and modified in various ways as described below. In addition, these variations and each of the above-mentioned embodiments may be combined as appropriate with one or more selected arbitrarily. It is also clear that an expert can conceive of various changes or modifications within the scope of the claims, which are naturally understood to be within the technical scope of the present invention.

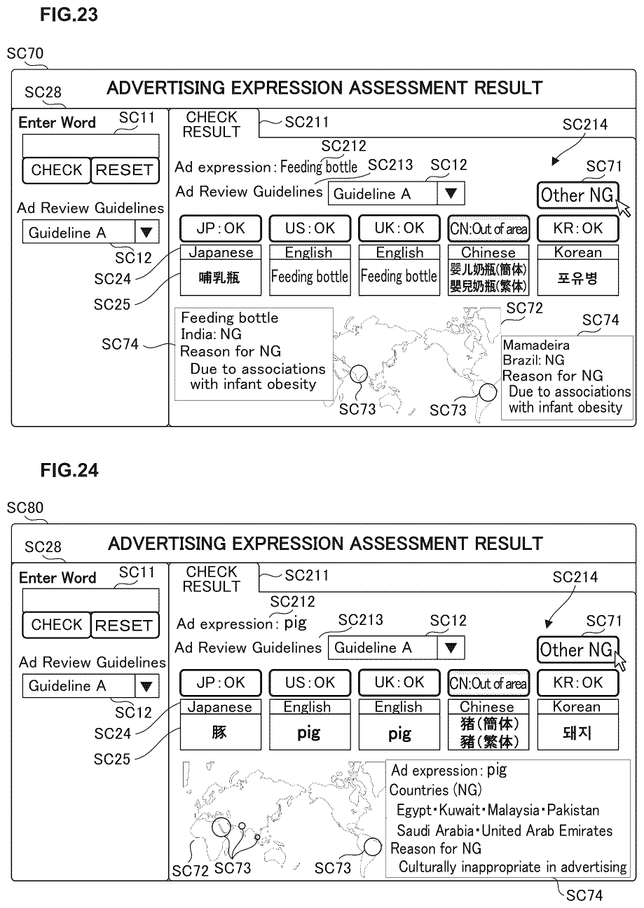

(1) The first variation of the assessment result display screen is explained with reference to FIG. 23. FIG. 23 shows a specific example of the assessment result display screen SC70 of the advertising expression according to the first variation, corresponding to FIG. 8. The assessment result display screen SC70 includes a world map display field SC72, with markers SC73 added to indicate the locations of countries where the advertising expression is Not OK for use. This allows for the display of countries and regions where the advertising expression is Not OK for use, in addition to the main displayed countries (Japan, the United States, the United Kingdom, China, and South Korea).

In this case, as shown in FIG. 23, by adding the Other Not OK SC71 display to the country-specific usage acceptability list SC214, the locations of countries and regions where the advertising expression is Not OK for use, other than those main displayed countries, are shown with marker SC73 when the cursor hovers over the Other Not OK SC71 display. Additionally, a pop-up display SC74 may be added to show the countries where the advertising expression is Not OK for use and the reasons for the Not OK status, indicated by marker SC73. For instance, FIG. 23 clearly demonstrates that the use of “baby bottle” as an advertising expression is OK in Japan, the United States, the United Kingdom, and South Korea under Ad review guideline A, but Not OK in India and Brazil. The reasons for this Not OK status, such as associations with infant obesity, are also presented. This insight facilitates the modification of the advertising expression and is applicable to other embodiments and variations as well. Alternative expressions for those countries may also be included in the pop-up display SC74.

The display data generated by the output unit 130 in the first variant includes a world map display and markers indicating at least the location of countries on the world map where the advertising expression is Not OK for use (not acceptable). This allows the display of the assessment result display screen SC70 on the terminal device 20, enabling the identification of countries on the world map where the advertising expression is Not OK. Particularly when the expression is Not OK in multiple countries, it's easy to view at a glance which countries or regions are affected. Additionally, the display data may include a pop-up display linked to the markers on the world map, showing at least the countries where the specific advertising expression is Not OK for use (not acceptable). This facilitates easy recognition of these countries marked on the world map.

(2) The second variant of the assessment result display screen is explained with reference to FIG. 24. FIG. 24 shows a specific example of the assessment result display screen SC80 of the advertising expression according to the second variant, corresponding to FIG. 23. The assessment result display screen SC80 is an example of culturally inappropriate advertising expressions. The advertising review guidelines include not only the laws and regulations of the country but also advertising expressions that are unacceptable in the culture. In such cases, the world map can be used to identify at a glance the countries or regions where the expressions are unacceptable for use. For example, FIG. 24 shows that “pig” as an advertising expression is acceptable for use in Japan, the United States, the United Kingdom, and South Korea under Ad review guideline A, but is not acceptable in Egypt, Kuwait, Malaysia, Pakistan, Saudi Arabia, and the United Arab Emirates when the cursor is placed over Other Not OK. Moreover, the reason for being unacceptable (culturally inappropriate) can be known as well.

(3) As for the assessment result display screen for the above-mentioned each embodiments and variations, the main displayed countries (Japan, the United States, the United Kingdom, China, and South Korea) are not limited to these. The first embodiment word input screen SC10, illustrates a word input as an advertising expression in first input field SC11, however, it is not limited to this, a phrase that is an advertising expression may be input in the first input field SC11. In the second and third embodiments, the word extraction unit 123 extracts words of web advertisements as an illustration, however, it may extract phrases as well.

### REFERENCE SIGNS LIST

100 Advertising expression assessment system, 10 Advertising expression assessment device, 11 Communication unit, 12 Control unit, 14 storage unit, 15 Program storage unit, 16 Data storage unit, 20 Terminal device, 21 Communication unit, 22 control unit, 23 storage unit, 24 input unit, 25 display unit, 121 acquisition unit, 122 text conversion unit, 123 word extraction unit, 124 translation unit, 125 assessment data selection unit, 126 Expression assessment unit, 130 Output unit, 161 User DB, 162 Country-specific advertisement assessment DB, 163 Description DB, 164 Alternative expression DB, 165 Assessment result DB, N Network, SC10 Word input screen, SC11 First input field, SC12 Second input field, SC13 Check button, SC14 Reset button, SC20 Assessment result display screen, SC211 Check result field, SC212 Advertising expression display field, SC213 advertising review guideline display field, SC214 usage acceptability list for each country, SC24 Language type field, SC25 Home country language description field, SC26 Reason field, SC27 Alternative expression field, SC28 Sidebar, SC40 Assessment result display screen, SC41 Check result field, SC415 Number display field, SC42 Site display field, SC422 Highlighting, SC423 Number display, SC424 Pop-up display, SC425 Scroll bar, SC60 Assessment result display screen, SC62 Text extraction sentence display field, SC70 Assessment result display screen, SC72 World map display field, SC73 marker, SC74 Pop-up display, SC80 Assessment result display screen.

1. An advertising expression assessment device comprising:
a storage unit that stores assessment data for determining the usage acceptability of an advertising expression in multiple countries based on advertising review guidelines,
an acquisition unit that obtains the advertising expression,
a translation unit that obtains language expressions translated into the language of each of said countries for the obtained advertising expression,
an expression assessment unit that determines the usage acceptability to ascertain whether an advertising expression is acceptable for use in each of said countries based on the assessment data, and
an output unit that outputs display data listing the language expressions for each of said countries and their respective usage acceptability.

2. The advertising expression assessment device according to claim 1, wherein:
the assessment data includes the country-specific language expressions and the country-specific usage acceptability for advertising expressions that are not acceptable in at least one country for each of the multiple review guidelines.

3. The advertising expression assessment device according to claim 2, wherein:
the advertising expressions are included in web advertisements,
the acquisition unit obtains the advertising expression based on the URL of the web advertisement, and
the display data includes data that displays at least the number of the advertising expressions not acceptable for use in each country.

4. The advertising expression assessment device according to claim 3, wherein:
the display data includes the display of the web advertisement with a highlight on an advertising expression that has been determined to be not acceptable in at least one of the countries, and
when the cursor is placed over the advertising expression with highlighted, a pop-up display appears, showing at least the countries where the use of the advertising expression is not acceptable.

5. The advertising expression assessment device according to claim 4, wherein:
the web advertisement is a video, and
the acquisition unit obtains the advertising expressions from speech-to-text converted data from the video based on the URL of said web advertisement.

6. The advertising expression assessment device according to claim 5, wherein:
the display data includes a display of a world map,
markers showing the location on the world map of the countries where at least the advertising expression is not acceptable, and
a popup display associated with said markers, showing the countries where at least the advertising expression is not acceptable.

7. The advertising expression assessment device according to claim 6, wherein:
the display data includes data that displays the reasons why the advertising expression is not acceptable in that country.

8. A tangible non-transitory computer-readable storage medium that stores a program for a computer to execute an advertisement assessment process for assessing advertising expressions for each of multiple countries based on advertising review guidelines, the advertisement assessment process includes the steps:
acquiring an advertising expression,
obtaining language expressions translated into the language of each of said countries for the obtained advertising expression,
determining a usage acceptability to ascertain whether the advertising expression is acceptable for use in each of said countries based on the advertising review guidelines, and
outputting display data listing the language expressions for each of said countries and their respective usage acceptability.

9. (canceled)
